(19) United States
(12) Patent Application Publication
(10) Pub. No.: US 2026/0303634 A1
(43) Pub. Date: Oct. 1, 2026

(54) ANOMALY DETECTION IN INDUSTRIAL CONTROL NETWORKS

(71) Applicant: SINGAPORE UNIVERSITY OF TECHNOLOGY AND DESIGN, Singapore (SG)

(72) Inventors: Gauthama Raman MANI IYER RAMANI, Singapore (SG); Aditya MATHUR, Singapore (SG); Guo Feng Eric NG, Singapore (SG); Zhan Yi Caven CHEW, Singapore (SG); Tiger LIM, Singapore (SG); Sanskar SHRIVASTAVA, Singapore (SG)

(21) Appl. No.: 19/477,106

(22) PCT Filed: Apr. 22, 2024
(86) PCT No.: PCT/SG2024/050260

§ 371 Date: Oct. 20, 2025

(30) Foreign Application Priority Data
Apr. 20, 2023 (SG) 10202301103U

(51) Int. Cl. H04L 9/40; G05B 19/418; H04L 43/028

(52) U.S. Cl. CPC H04L 63/1425; G05B 19/4184; H04L 43/028

(57) ABSTRACT

Systems and methods from detecting anomalies in an Industrial Control System (ICS) are disclosed. The process involves receiving network signals communicated in an Information Technology (IT) domain and an Operational Technology (OT) domain or across the IT and OT domains of the ICS, processing the received network signals by an IT domain anomaly detection module to identify one or more anomalies in network traffic observed from the data packets, and processing the received network signals by an OT domain anomaly detection module to identify one or more anomalies in individual ones of said data packets. Detected anomalies are then transmitted to an intrusion monitoring terminal.

### CROSS-REFERENCE TO RELATED APPLICATION

This application is a 371 National Stage of International Application No. PCT/SG2024/050260, filed on 22 Apr. 2024, which claims the benefit of priority of Singapore Patent Application No. 10202301103U filed on 20 Apr. 2023, the content of which being hereby incorporated by reference in its entirety for all purposes.

### TECHNICAL FIELD

The present invention relates, in general terms, to systems and methods for anomaly detections in industrial control networks. More particularly, the present invention relates to, but is not limited to, systems and methods for the detection of anomalies both in the information technology (IT) and operational technology (OT) domains.

### BACKGROUND

An Industrial Control System (ICS) consists of a physical process controlled by a computation and communications infrastructure. Typically, an ICS consists of multiple stages, where a Programmable Logic Controller (PLC), or a Remote Terminal Unit (RTU), controls each stage. It is to be appreciated that the term PLC also refers to an RTU in this document. Each PLC controls a sub-process. The control actions are based on the current process state obtained through a network of sensors, and the control actions subsequently alter the process state. For example, in an industrial air conditioning system, a PLC may start a motor to condition the air in an area. The motor must be stopped or shift to a low power state, when the air reaches a predetermined temperature. The temperature of the air is known to the PLC through a temperature sensor. At any instant, the PLCs receive data from sensors, compute control actions, and apply these actions to specific devices commonly referred to as actuators.

Critical infrastructure, herein referred to as “plant”, often forms part of a network of the ICS. ICSs are used in modern plant, for controlling operation of the plant. Components of the ICS, such as PLCs, are networked into the communication infrastructure of the ICS, often using wired or wireless communications. Such connections render an ICS susceptible to cyber attacks. Such attacks may compromise one or more of the communication links between sensors, actuators and the PLCs, as well as across the PLCs and Supervisory Control And Data Acquisition (SCADA) workstation. Each such link is considered as an attack point in the ICS. Once a link has been compromised, an attacker can use one of several strategies to send fake state (sensor) data to one or more PLCs, or bypass the PLC and directly control an actuator. Such attacks are able to cause an undesirable response that may lead to system shutdown and/or device damage.

Detection of cyber attacks is typically achieved through one of two commercially available technologies: network firewalls and anomaly detectors. Plant commonly use firewalls to manage access to the plant network. While firewalls are necessary to protect plant network, they are hopelessly inadequate in preventing advanced cyberattacks such as the well-known Stuxnet, and the more recent attack on the Colonial pipeline.

Firewalls are enhanced using anomaly detectors. Such detectors are widely available commercially. Commercial detectors often use machine learning to create one or more models of network traffic. When deployed, these models continuously monitor the network and report an anomaly in the network traffic. Though such anomaly detectors do provide added security over firewalls, they have two major shortcomings-they generate an unacceptable number of false positives, and they generate alerts directed at IT specialists, and not plant operators. False positives lead to reduced confidence in the deployed anomaly detector. Alerts aimed at IT specialists lead to a significant delay in identifying what went wrong in the plant and why the plant is behaving abnormally.

iTrust, a multidisciplinary research centre located in the Singapore University of Technology and Design, has developed a technology for anomaly detection that gets data from the OT domain of the plant, and not the network domain. Extensive testing and piloting of this technology has revealed that it has ultra-low rates of false positives (<0.01%) while maintaining an ultra-high rate of anomaly detection (>99%). When deployed, this technology generates alerts that are in plain English and easily understood by a plant operator. However, embodiments of this technology come with two key shortcomings. They ignore network traffic anomalies, and they require more effort to implement due to the use of Physics and Machine Learning.

Thus, it is very desirable for design engineers of an ICS to understand how an attack might bring about anomalous behaviour and how these may be detected. One object of the present invention is to afford anomalous behaviour detection.

### SUMMARY

The primary objective of the IT-OT bridge is to detect and prevent process anomalies in operational Industrial Control Systems (ICS). Unlike in conventional anomaly detection systems, as well as commercially available products that rely on identifying signatures in network traffic to detect cyber intrusions, the IT-OT bridge employs a mix of network traffic modelling as well as modelling data obtained through its deep inspection.

As used herein, the term “IT” refers Information Technology, relating to network traffic, whereas the term “OT” refers to Operational Technology, reflected in data extracted from network traffic by deep inspection of the packets in transmission. Thus, an IT-anomaly refers to an unexpected condition in the network traffic that is not in accordance to the network design. An OT-anomaly refers to a condition in the physical plant indicative of a plant malfunction.

Existing commercially available detectors detect anomalies at the network level whereas those created in iTrust do so at the OT level. The present invention, referred to as an IT-OT bridge, does so at both levels and offers an integrated view of the anomalies.

Disclosed herein is a system for detection of anomaly in an Industrial Control System (ICS), the system comprising:
a memory;
one or more processors;
a network interface configured to receive network signals from the ICS, the network signals comprising data packets, the memory comprising program code executable by the one or more processors to:
process the received network signals by an Information Technology (IT) domain anomaly detection module to identify one or more anomalies in network traffic observed from the data packets;
process the received network signals by an Operational Technology (OT) domain anomaly detection module to identify one or more anomalies in individual ones of said data packets;
transmit data of the identified one or more anomalies in the IT domain or OT domain to an intrusion monitoring terminal.

Also disclosed is a computer implemented method for detection of anomaly in an Industrial Control System (ICS), the method comprising:
receiving network signals communicated in an Information Technology (IT) domain and an Operational Technology (OT) domain or across the IT and OT domains of the ICS;
processing the received network signals by an IT domain anomaly detection module to identify one or more anomalies in network traffic observed from the data packets;
processing the received network signals by an OT domain anomaly detection module to identify one or more anomalies in individual ones of said data packets;
transmitting data of the identified one or more anomalies in the IT domain or OT domain to an intrusion monitoring terminal.

### BRIEF DESCRIPTION OF THE DRAWINGS

Embodiments of the present invention will now be described, by way of non-limiting example, with reference to the drawings in which:

FIG. 1 is a schematic of a system architecture for an ICS and IT-OT bridge;

FIG. 2 is a method for detecting anomalies by deriving and executing invariants describing the behaviour and properties of the ICS; and

FIG. 3 shows an example communications architecture for the control portion of a multi-stage ICS.

### DETAILED DESCRIPTION

This invention relates to a novel methodology for timely detection of intrusions within an Industrial Control System (ICS), prior to their propagation to the Operational Technology (OT) level. By detecting and preventing these intrusions before they may adversely affect the physical processes of the ICS, the invention ensures that the system continues its normal operation.

Current systems provide reactive alerts that are only raised after the impact of the attack has been realized, produce an unacceptable number of false alarms, and are unable to detect multi-point attacks that mask the impact of an attack by spoofing several other state measurements. The present architectures, each referred to as an IT-OT bridge, can address these shortcomings, using deep packet inspection to accurately detect cyber intrusions at both the IT and OT levels. The resulting IT-OT bridge boasts an ultra-low false alarm rate of nearly 0% and an ultra-high detection rate of nearly 98%.

Deep packet inspection (a type of network packet filtering that examines the contents of a pack, in full—i.e., all of the contents) is used to extract data and relate it to the OT traffic. Specifically, the payload of network packets flowing in and out of critical assets is analyzed to detect the presence of intrusions. By leveraging this approach, the actions of attackers can be accurately identified at an early stage before the impact of the attack is realized in the physical process under ICS control. The IT-OT bridge was implemented and evaluated in the SWaT and WADI testbeds using several real-time stealthy and coordinated attacks. The key features that distinguish the IT-OT bridge from several existing anomaly detectors are its ability to accurately detect anomalies and explain the semantics of the detected anomalies.

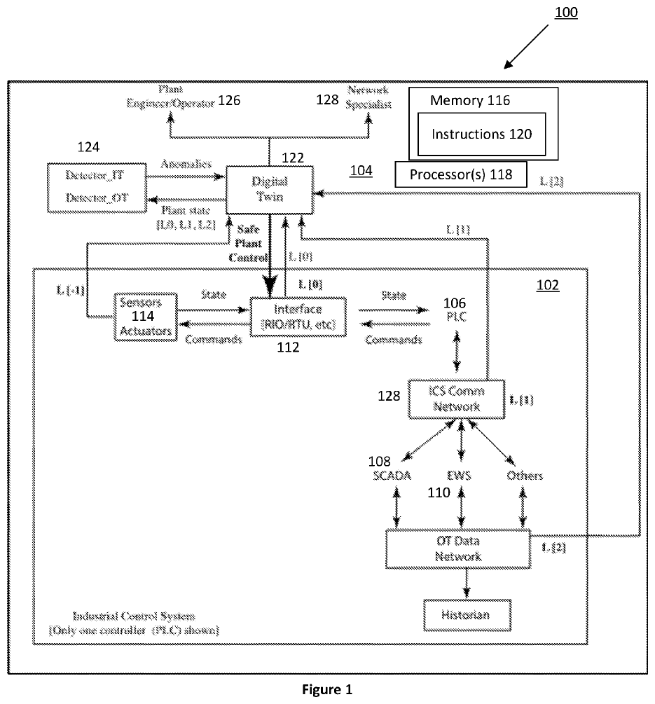

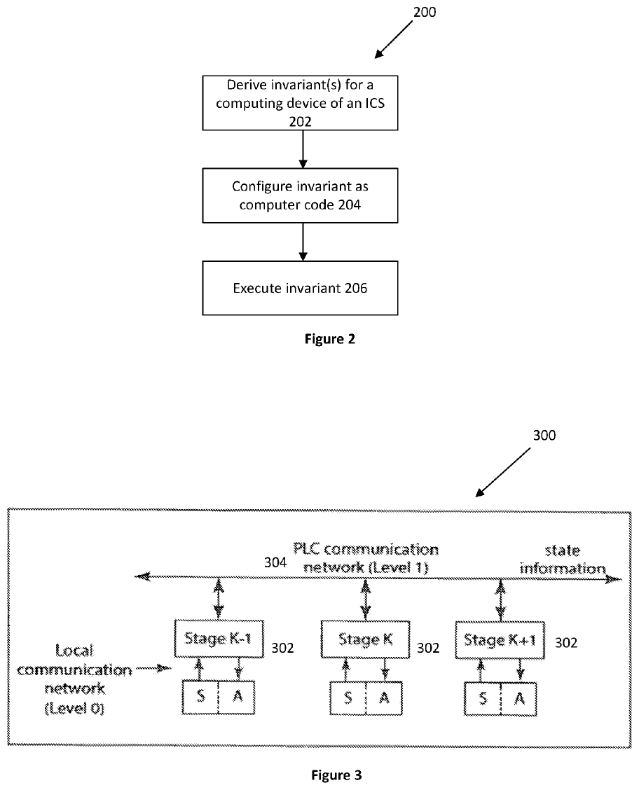

With reference to the schematic 100 in FIG. 1, two sets of components are shown: an Industrial Control System (ICS) 102 enclosed in an inner box and IT-OT bridge 104 comprising the components outside of the inner box. The ICS 102 shown comprises a PLC 106, a Supervisory Data Acquisition and Control System (SCADA) 108, Engineering WorkStation (EWS) 110, network interface 112, sensors and actuators 114. In some embodiments, more than one of one or more of the above components (e.g., PLC, SCADA, EWS, sensors and actuators) of the ICS can be provided.

The IT-OT bridge 104 is a system for detection of anomalies in the ICS. The IT-OT bridge 104 includes memory 116 and one or more processors 118. The IT-OT bridge 104 also includes a network interface, presently part of a digital twin 122, though it may be a standalone interface in other embodiments. The network interface is configured to receive network signals from the ICS 102, the network signals comprising data packets. The IT-OT bridge operates on both IT and OT levels. The IT-OT bridge can detect and report the root cause of anomalies (e.g., in network traffic behaviour and/or in operating behaviour), preventing them before their actual impact is realized in the physical processes of the plant. By monitoring both IT and OT levels of the plant, the alerts can be accurately correlated to particular processes, packet injection or packet theft timing, and the potential intention of the packet to clearly explain the semantics of the detected anomalies. For example, in a water distribution system with a tank and inflow and outflow pumps, packets may be injected to confound a control system that controls the pumps. The injected packets may indicate that an inflow pump is not in operation when it is, in fact, in operation, or may slightly reduce the tank fill level reading over multiple packets, to incrementally increase the discrepancy between actual tank fill level and the fill level as recorded by the control system, to cause an overflow event. Identifying the packets using the IT-OT bridge would allow the content of the packets to be analysed and the intention of the packets to be semantically determined. This semantic determination may be, for example, determining what the outcome would be if the packet had not been detected—this may be determined through a digital twin such as digital twin 122, shown in FIG. 1.

The IT-OT bridge 104 includes a detector module 124 in communication with the digital twin 122. The detector module 124 stores other modules either in hardwired or software implementations. The memory 116 stores program code executable by the processor(s) 118 to process the received network signals using both an IT domain anomaly detection module and an OT anomaly detector module, both the IT and OT detector modules being housed in detector module 124. The IT domain anomaly detector module processes the data packets to identify anomalies in network traffic observed from the data packets. Such anomalies can include unexpected packets or missing packets, packets being received a greater or lesser frequency than expected, and other characteristics of network traffic. The OT domain anomaly detector module processes the received network signals to identify anomalies in individual ones of said data packets. Such anomalies can include values for control settings that differ from expected values, fall outside expected ranges and so on.

On detection of an anomaly, data corresponding to the anomaly is transmitted from the digital twin 122 to one or more intrusion monitoring terminals. To avoid delays in responding to detected anomalies—e.g., where an anomaly is sent to an IT staff member or network specialist that would be more appropriate to send to an engineer or operator—the intrusion monitoring terminals include a plant engineer/operator terminal 126 and a separate network specialist terminal 128.

An overall ICS, such as power grid and water treatment systems, consists of a distributed supervisory control system (which also may be individually controlled by a SCADA). The control system itself is a collection of stages each controlling a specific portion of the ICS. Each stage has a Programmable Logic Controller (PLC) responsible for controlling the sub-process associated with that stage (e.g., control of a pump or power generator turbine). Each PLC controls a stage of the plant by receiving the state of the physical components from sensors and sends commands to affect the actuators. This communication occurs via the L0 network discussed below. The actuators include items such as pumps, valves, compressors, and generators. A plant generally contains multiple PLCs that communicate with each other, SCADA, and the EWS, via the level L 1 network, also discussed below. Data flowing through the L1 network is also sent to devices such as a Historian that records it for future analysis. L(−1) is a special network designed to obtain true measurements from sensors. These measurements are used by the anomaly detectors to ensure that the data received by the controllers and SCADA is consistent with the readings received via L(−1).

A stage is considered partially compromised if any one or more, but not all entities in that stage are compromised and completely compromised if all entities at that stage are compromised. Such attacks are referred to as single-stage single point when only one entity in a stage is compromised, or simply SSSP, single-stage multi point, or simply as SSMP when only one stage is fully compromised, multi-stage single point when multiple stages but only one entity in stage is compromised, or simply MSSP, and multi-stage multi point when more than one sensor in more than one stage are compromised, or simply MSMP attacks. Single stage single point (SSSP) attacks are the simplest of these four types of attacks. This generic attack scenario becomes realistic in the presence of system vulnerabilities or when a disgruntled insider, or an external malicious actor has access to one or more stages of the ICS either directly or via the Internet.

The network traffic is captured from one or more networks of the ICS 102. Presently, network traffic is received from interface 112 over network Level 0 (L0). As shown in the architecture 300 of FIG. 3, the PLC at each stage 302 communicates with a set of sensors and actuators, labelled as S and A, respectively. Communication is over a local communications network 304. This local network is also referred to as the field-bus network. It could be, for example, a ring network across which sensors send local state information to the PLCs, and the PLCs in turn send control command to the actuators. This network traffic relates to Remote Input/Output (RIO) and/or Remote Terminal Units (RTUs) data, RIOs and RTUs being examples of PLCs 106. This data is that which is used to control plant or sub-process.

Network traffic is also received from the ICS communication network 128, over network Level 1 (L1). State information is local to a stage, i.e., to a PLC. Level 1 (L1) network is used to share state data among the PLCs. This network traffic includes data packets passing between the SCADA 108, EWS 110 and other monitoring systems, and the PLCs 106. Control commands to alter the state of an actuator are sent to actuators by the respective PLCs. Actuators often contain sensors used by a PLC to obtain its state. Such sensors are included in set S shown in FIG. 3. The PLCs themselves thus communicate among each other using the Level 1 network.

Network traffic is also received over network L2, relating to OT domain data—i.e., data from plant. Lastly, sensor and actuator values are received directly from the sensors and actuators over network L(−1). This enables the digital twin (described below) to compare the anticipated behaviour corresponding to the sensor and actuator values to the behaviour resulting from the data packets received over networks L0, L1 and L2.

The IT domain anomaly analysis is performed in terms of packets captured in transmission over the network, rather than the content of the packets. During normal plant operation, network traffic among critical assets, namely PLCs, SCADA, etc., is collected. Features are extracted from the network traffic by comparing network traffic to relevant ICS protocols and modelled using a deep learning algorithm. The deep learning algorithm is trained to detect behavioural changes in network traffic. Training can be based on one or both of normal network traffic (e.g., network traffic that can be expected during normal operation of plant) and abnormal or anomalous network traffic (e.g., network traffic that is not in alignment with expected traffic, such as unexpected or missing packets—for example, if plant can be expected to send a monitoring packets or signals once per second, then receiving two or more packets or signals in a one second period would reflected an anomaly, as would receiving no packet for more than one second, plus or minus a small potential network latency variation). The trained model can therefore be utilized for detecting any behavioural changes in the network traffic due to intrusions. If a potential intrusion is identified, packets associated with the intrusion (e.g., received within a certain time period of the detected intrusion, or from which the intrusion was detected, such as the example of two or more packets in a one second period where only a single packet should be expected) are decoded. The payloads of the decoded packets are analysed to extract information for identifying the attacker or intruder, and the information is reported to the plant operator in real-time.

The IT anomalies are detected using the IT domain detector module, that module comprising the trained model mentioned above. The IT domain detector module works in tandem with the digital twin 122. In a first phase, the digital twin 122 is generated by acquiring data from the historian 130. The historian 130 periodically records the values of continuous and discrete state variables (e.g., the state of each piece of plant) of the ICS 102. The period of recordal can be selected, and may be one per second. The digital twin 122 is generated using a machine learning model to utilise the data acquired form the historian 130 to learn process dynamics and control strategies during normal operation of the ICS 102 (i.e., operation without attack). The digital twin 122 may comprise model of the behaviour of continuous state variables (e.g. fill level of a water tank or temperature) and a model of the dependencies across the continuous state variables and discrete state variables (e.g., ON/OFF state of particular plant). The state variables may be derived from a piping and instrumentation diagram (P&ID) or other system map or diagram, to produce invariants—invariants are conditions that must hold given a particular state of the plant. Thus, invariants capture the relationships among the physical properties of the underlying process of the ICS. Some invariants capture the relationship across continuous state variables, and others capture the relationship across continuous and discrete state variables.

Any appropriate machine learning architecture may be used, implementing any desired analysis model. For continuous state variables, the output of the machine learning model may be a regression algorithm to continuously map between continuous state variables. For example, for the continuous variable of “water level” in a reservoir, related variables are the “inflow rate” and “outflow rate”. Knowing the water level, inflow rate and outflow rate allows the next state of the “water level” variable to be calculated. For discrete state variables, generally having a binary state—e.g., ON or OFF-the relationship with the continuous state variables may be learned as a classification problem, such as a binary classification problem or a decision tree (particularly for hierarchical relationships). For example, for the continuous variables of “water level”, “inflow rate” and “outflow rate” and the discrete variables of “inflow pump ON/OFF” and “outflow pump ON/OFF”, the next state of the “water level” can be predicted.

In each case, models of various types and architectures may be trained to determine which best approximates the plant in particular circumstances or with respect to particular variables. Any models that perform more poorly than other models—e.g., provide a less accurate prediction of next state of the plant for a given set of variables—may be pruned. The digital twin 122 may therefore comprise all models that are not pruned.

The IT domain detector module analyses network traffic to determine if unexpected packets are received. The unexpected packets may be packets relating to a state of the system that contradict a state of the system a determined by the digital twin 122.

The OT anomalies are detected using a Distributed Anomaly Detector (DAD) referred to as Detector-OT in FIG. 1. The method 200 (which is a distributed detection method) is capable of detecting single stage multi-point attacks on an ICS. Such attacks endeavour to compromise multiple sensors or actuators at any one stage of an ICS. If successful, a controller could be entirely compromised and prevent the controller from detecting the attack. The method 200 derives and uses physical invariants derived for each stage of the ICS from its design, for detection of attacks.

To realise the method 200, a suitable model of an ICS must be constructed. The model is achieved by developing a set of invariants. The invariants may be specified in or otherwise derivable from the system map, such as a P&ID, per step 202. Each PLC contains a control program that receives data, computes control actions and applies these to the actuators it controls. Computation of control actions is based on a condition evaluated using data received from the sensors. This could be a simple condition involving data from one sensor, or a compound condition involving data from multiple sensors some of which may require communication with other PLCs. After derivation at step 202, the invariants representing these behaviours can be coded into computer code per step 204, to enable their execution (per step 206) on receipt of state variables as reflected in data packets received from the ICS in a network signal.

Sensors and actuators are distributed across the stages of the ICS. These include sensors that relate to the physics of the process, for example water level in tanks, flow indicators, and pressure indicators. In addition there are sensors that measure properties, for example chemical properties of water including pH, conductivity and hardness. Each PLC has its own set of sensors and actuators connected through a ring network or other L0 network. Thus, when a PLC needs to obtain state information from another PLC, it must request such information via a suitable command; the requested data is sent over the Level 1 network.

An attack point is a specific component or a communication link. A pessimistic approach is taken implying that all wireless links are assumed to be vulnerable to cyber attacks. The (attack detection) method 200 uses state-based invariants. A “process invariant,” or simply an invariant, is a mathematical relationship defined among “physical” and/or “chemical” properties of the process controlled by the PLCs in an ICS. Together, at a given time instant, a suitable set of such properties constitutes the observable state of the ICS. For example, in a water treatment plant, such a relationship includes the correlation between the level of water in a tank and the flow rate of incoming and outgoing water across this tank. The properties are measured using sensors during the operation of the ICS and captured by the PLCs at predetermined time instants. The measurements are often also saved in a historian (e.g. a workstation) for subsequent analysis. An invariant is thus a specific rule/condition aimed at detecting an anomaly in the behaviour of the underlying process controlled by an ICS.

Two types of invariants are generally considered: state dependent (SD) and state agnostic (SA). While both types use states to define relationships that must hold, the SA invariants are independent of any state based guard, whereas SD invariants are. An SD invariant is true when the CPS is in a given state; an SA invariant is always true.

As an example, consider the fact that when the motorized valve is open, the flow rate indicator must be non-zero. In general, an SD invariant will be written as follows:
S1→S2
   wherein S1 and S2 denote state-based conditions of one or more components of an ICS, such that S2 must hold whenever S1 holds. Such conditions could be on a portion of the system state or the complete state.

Derivation of SD invariants is based on the system design of the ICS, and its various components. The system design is captured using State Condition Graphs (SCG), but not limited to SCGs. An SCG could be constructed at the design stage of an ICS, before the control code is available, or later.

It is noted that an SD invariant can include conditions from across the various stages of a CPS. However, doing so could make an invariant complex and require significant amount of sensor data exchange across the PLCs. To reduce complexity, SD invariants may use only variables from neighbouring stages of the ICS.

Under normal system operation, an SA invariant must be always true regardless of the system state. To demonstrate the effectiveness of the proposed (attack detection) method 200, one SA invariant may be derived for each plant in an ICS to detect SSMP attacks that affect the plant. In a water tank embodiment, the invariants are based on the flow of water and water level in a tank, and hence are identical in terms of the mathematical relationship that they capture.

The invariants are used by the OT detector to detect abnormal states of the ICS. An abnormal state can be determined by comparing the states of the system, at one or more points in time, to the invariants to determine if the states of the system are possible. For example, for a given inflow rate Fᵢ, outflow rate Fₒ and a first tank water level L₁, a second water level measurement L₂ (i.e., state of the tank) taken a period of time t after L₁ is only possible if it is within an acceptable variance (which may be zero) from L₁+t*(Fᵢ−Fₒ).

If either the OT detector or IT detector detects an anomaly, the digital twin 122 generates an alert. Alerts generated by the IT-OT bridge are available to plant operators and network specialists. Alerts generated due to network traffic anomalies are likely to be understood by network specialists who may use these alerts for forensics. OT anomalies generate alerts that are easy to understand by plant operators. While alerts in network traffic might not lead to immediate action by network specialists, alerts due to OT anomalies are likely to alert plant engineers who may take, or request, an immediate action to prevent the plant from moving into a unrecoverable state.

The IT-OT bridge 104 detects attacks by monitoring data packets from the various networks of the ICS 102. The IT-OT bridge 104 contains modules that capture network data and extract OT information from it. This is done prior to the data being passed to the digital twin and the detectors. The IT-OT bridge continuously monitors the network traffic flowing in and out of the critical components, such as SCADA, PLCs, and RIOs, using a deep packet inspection approach. Doing so ensures the correctness of the payload in real-time, detecting any abnormalities that may arise. In the case of an anomaly, the IT-OT bridge 104 accurately detects the attacker's actions, such as altering sensor measurements, changing actuator statuses, or alerting control logic in any PLC. These detections are reported to the plant operator and the network specialist, who can initiate recovery actions before the impact of the attack leads to process anomalies. Any detected violation of, or anomaly in, an invariant is immediately reported to the plant engineer. The IT and OT traffic is also monitored by the systems described above, that leverage historical data from historian 130, and generate appropriate alerts when an anomaly occurs. Data from L0, L1, and L2 networks is passed to the Digital Twin 122 which in turn makes it available to the appropriate detector. Thus, the raw data packets from the networks of the ICS 102 is compared with the data generated by the digital twin and received directly from sensors and actuators 114, to detect whether the data packets indicate the state of the ICS is within acceptable bounds of the state predicted by the digital twin 122, outside those bounds (e.g., system state shows a water level that is not possible based on the previous water level and inflow and outflow rates) or in contradiction of the state predicted by the digital twin 122 (e.g. flow rate is non-zero yet pump is not switched ON).

It will be appreciated that many further modifications and permutations of various aspects of the described embodiments are possible. Accordingly, the described aspects are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A system for detection of anomaly in an Industrial Control System (ICS), the system comprising:
a memory;
one or more processors;
a network interface configured to receive network signals from the ICS, the network signals comprising data packets, the memory comprising program code executable by the one or more processors to:
process the received network signals by an Information Technology (IT) domain anomaly detection module to identify one or more anomalies in network traffic observed from the data packets;
process the received network signals by an Operational Technology (OT) domain anomaly detection module to identify one or more anomalies in individual ones of said data packets;
transmit data of the identified one or more anomalies in the IT domain or OT domain to an intrusion monitoring terminal.

2. The system of claim 1, wherein the ICS comprises at least one sensor and at least one operational plant each producing ones of said data packets, the OT domain anomaly detection module performs detection by:
deriving, from the ICS, a plurality of invariants, each invariant defining a set of conditions describing a physical process controlled using the ICS;
formulating a digital twin of the ICS based on the invariants; and
detecting OT anomalies by comparing a state of the ICS to a state of the digital twin, for the data packets from each sensor and operational plant, using deep packet inspection.

3. The system of claim 2, wherein deep packet inspection comprises extraction of data from the data packets of the received network signals and establishing a relationship between the extracted data and signals in the OT domain.

4. The system of claim 2, comprising a plurality of PLCs, each PLC providing data packets of the network signals, wherein deriving, from the ICS, a plurality of invariants comprises deriving, for each PLC, at least one invariant.

5. The system of claim 1, wherein the IT domain anomaly detection module and the OT domain anomaly detection module comprise one or more signal signatures for identifying anomalies.

6. The system of claim 1, wherein the IT domain anomaly detection module is configured to detect unexpected conditions in the network signals, without reference to content of the data packets.

7. The system of claim 1, wherein the one or more processors are further configured to detect an intrusion action associated with at least a subset of the one or more anomalies.

8. The system of claim 1, wherein the received network signals comprise network traffic from any one or more than one of L−1, L0, L1 or L2 networks of the ICS.

9. The system of claim 1, wherein the one or more processors are further configured to generate a semantic explanation of at least one of the identified one or more anomalies.

10. A computer implemented method for detection of anomaly in an Industrial Control System (ICS), the method comprising:
receiving network signals communicated in an Information Technology (IT) domain and an Operational Technology (OT) domain or across the IT and OT domains of the ICS, the network signals comprising data packets;
processing the received network signals by an IT domain anomaly detection module to identify one or more anomalies in network traffic observed from the data packets;
processing the received network signals by an OT domain anomaly detection module to identify one or more anomalies in individual ones of said data packets;
transmitting data of the identified one or more anomalies in the IT domain or OT domain to an intrusion monitoring terminal.

11. The method of claim 10, wherein the ICS comprises at least one sensor and at least one operational plant each producing ones of said data packets, and processing the received network signals by the OT domain anomaly detection module comprises:
deriving, from the ICS, a plurality of invariants, each invariant defining a set of conditions describing a physical process controlled using the ICS;
formulating a digital twin of the ICS based on the invariants; and
detecting OT anomalies by comparing a state of the ICS to a state of the digital twin, for the data packets from each sensor and operational plant, using deep packet inspection.

12. The method of claim 11, wherein deep packet inspection comprises extraction of data from the data packets of the received network signals and establishing a relationship between the extracted data and signals in the OT domain.

13. The method of claim 11, wherein the ICS comprises a plurality of PLCs, each PLC providing data packets of the network signals, wherein deriving, from the ICS, a plurality of invariants comprises deriving, for each PLC, at least one invariant.

14. The method of claim 10, wherein the IT domain anomaly detection module and the OT domain anomaly detection module comprise at least one or more signal signatures for identifying anomalies.

15. The method of claim 10, wherein processing the received network signals by the IT domain anomaly detection module to identify one or more anomalies in network traffics observed from the data packets, comprises detecting unexpected conditions in the network signals, by analysis of network traffic, without reference to content of the data packets.

16. The method of claim 10, wherein the method further comprises detection of an intrusion action associated with at least a subset of the one or more anomalies.

17. The method of claim 10, wherein the received network signals comprise network traffic from any one or more than one of L−1, L0, L1 or L2 networks of the ICS.

18. The method of claim 10, wherein the method further comprises generating a semantic explanation of at least one of the identified one or more anomalies.
